(19) United States
(12) Patent Application Publication
(10) Pub. No.: US 2024/0395466 A1
(43) Pub. Date: Nov. 28, 2024

(54) MANUFACTURING METHOD AND MANUFACTURING SYSTEM FOR A CAPACITOR

(71) Applicant: Rubycon Corporation, Nagano (JP)

(72) Inventor: Tomonao Kako, Nagano (JP)

(73) Assignee: Rubycon Corporation, Nagano (JP)

(21) Appl. No.: 18/693,619

(22) PCT Filed: Sep. 27, 2022
(86) PCT No.: PCT/JP2022/035807

§ 371 Date: Mar. 20, 2024

(30) Foreign Application Priority Data
Sep. 28, 2021 (JP) 2021-157896

(51) Int. Cl. H01G 4/33; H01G 4/008; H01G 4/012; H01G 4/14; H01G 4/18; H01G 13/00

(52) U.S. Cl. CPC H01G 4/33; H01G 4/008; H01G 4/012; H01G 4/145; H01G 4/18; H01G 13/00

(57) ABSTRACT

There is provided a method of manufacturing a capacitor (1), the capacitor (1) including a main body (10) in which dielectric layers (13) and electrode layers (11) are alternatively laminated, with at least part of the main body connected to external electrodes (20). The method of manufacturing includes a step (89) of forming an electrode layer on a dielectric layer. The forming of the electrode layer includes: a step (83) of forming a first metal layer including a connecting part, which is connected to the external electrode, and an internal electrode part; and a step (85) of forming a second metal layer on the connecting part. In addition, the method includes a step (82) of patterning to form the first pattern and a step (84) of patterning to form the second pattern using a second material that evaporates when the second metal layer is formed.

### TECHNICAL FIELD

The present invention relates to a manufacturing method for a capacitor.

A polymer multi-thin-layer capacitor described in Japanese Laid-open Patent Publication No. 2021-19133 includes: a chip-shaped multilayer body in which dielectric layers and internal electrode layers, each of which includes a first metal layer formed by vapor deposition of a first metal on a dielectric layer and a second metal layer formed by vapor deposition of a second metal on the first metal layer, are alternately laminated (stacked) and joined together; and external electrodes respectively formed at one end and another end of the multilayer body. The multilayer body includes first regions, where dielectric layers on which the first metal is formed are alternately laminated, and edge regions, where the second metal is formed on parts of each first metal layer connected to the one end and the other end and are alternately laminated. The first region includes a region that functions as a capacitor, and the edge regions are formed with heavy edges.

### SUMMARY OF INVENTION

Among film capacitors, there is a known heavy edge structure. That is, to improve self-recovery, the internal electrodes that form the capacitance are thinly formed but electrodes that are provided at both ends to be connected to external electrodes are thickly formed as the heavy edge structure. Even among thin polymer multi-thin-layer capacitors with a multilayer structure composed of dielectric layers made of resin and electrode layers, using a heavy edge structure to achieve favorable connectivity with external electrodes, favorable withstand voltage characteristics, and also a desired capacitance is known.

In recent years, there has been demand for capacitors with an even higher withstand voltage and a low ESR (Equivalent Series Resistance). Even when a heavy-edge structure is used, if the thickness is reduced to sufficiently increase the surface resistivity (sheet resistivity) of an electrode part (internal electrode part) of the capacitor part in order to increase the withstand voltage, the thickness of the connecting parts will also become thinner. This means that the connection resistance of the connection parts increases, making it difficult to sufficiently reduce the ESR. On the other hand, if attempts are made to make the connecting parts thicker, it becomes difficult to limit the thick film region with respect to the thin internal electrode part, and due to the risk of this interfering with the internal electrode part, there is the risk of degradation in the performance of the capacitor, which lowers quality.

One aspect of the present invention is a method of manufacturing a capacitor. The capacitor includes a main body in which dielectric layers and electrode layers are alternatively laminated, and at least part of the main body is to be connected to an external electrode. This method of manufacturing includes forming an electrode layer on a dielectric layer, wherein the forming of the electrode layer includes forming a first metal layer including a connecting part, which is to be connected to the external electrode, and an internal electrode part, and forming a second metal layer on the connecting part. The method of manufacturing further includes: patterning, before the forming of the first metal layer, on the dielectric layer to form a first pattern for separating one end of the connecting part from the internal electrode part using a first material that evaporates when the first metal layer is formed; and patterning, between the forming of the first metal layer and the forming of the second metal layer, to form a second pattern using a second material that evaporates when the second metal layer is formed in a region including at least part of the first gap in the first metal layer formed by the first pattern.

According to this method of manufacturing, by forming the electrode layer split into the formation of a plurality of metal layers, it is possible to form, when forming the first metal layer, the first pattern by patterning so that the first pattern evaporates due to the heat of the metal supplied in a vaporized or fluidized state and to form, when forming the second metal layer, the second pattern by patterning so that the second pattern evaporates due to heat in the same way. Accordingly, the materials that are patterned to form respective patterns can evaporate and disappear every time or be placed in a state where the materials have hardly any effect on downstream manufacturing processes. It is possible to improve the accuracy of the deposited locations of thick film regions made up of a plurality of metal layers to prevent interference between thick layer regions and thin layer regions and prevent the materials that form the patterns that become the margins during layer formation from mixing with the material deposited to form the dielectric layer, which suppresses deterioration in performance. On the other hand, if the patterns that form the margins were to evaporate and disappear every time, there would be the problem of dealing with gaps formed by previous patterns when metal layers are stacked. In the manufacturing method according to the present invention, by further performing patterning to form a second pattern in a region including at least a part of the first gap in the first metal layer formed by the first pattern, it is possible to maintain the first gaps and suppress short circuits in the first metal layer due to the second metal layer. By defining the structure as an electrode layer composed of a plurality of metal layers, it is possible to increase the thickness only in locations where this is desirable.

This method of manufacturing may further include patterning to form a stopper, which sets a position at an opposite end of the second metal layer to an end formed by the second pattern, using the second material in parallel with the patterning to form the second pattern, which can further improve the formation accuracy of the thickened regions. The patterning to form the stopper may use a different amount of the second material than the amount of the second material used in the patterning to form the second pattern. The patterning to form the second pattern may include wobbling the position of the second pattern in a range where the position of the second pattern does not exceed the first gap. It is possible to soften the concave or stepped shape produced by the second pattern in a range where the first gap does not become filled in, which makes it possible to suppress the effect of the concave shape of the first gap on the form of the dielectric layer formed on the metal layer, and to provide a capacitor with stable quality including a multilayer main body portion.

This method of manufacturing may include forming the dielectric layer, wherein the forming of the dielectric layer includes vapor deposition of a resin material that forms (constructs) the dielectric layer in a reduced pressure environment. The forming of the first metal layer may include vapor deposition of a first metal that forms (constructs) the first metal layer on the dielectric layer, and the forming of the second metal layer may include vapor deposition of a second metal that forms (constructs) the second metal layer on the first metal layer. The method of manufacturing may further include curing the resin, which is thermosetting, following the vapor deposition of the resin material. The first metal may include one of aluminum and aluminum alloy, and the second metal may include one of zinc and zinc alloy. The patterning to form the second pattern may be patterning using the second material with a different boiling point to the boiling point of the first material. The patterning to form the second pattern may use the second material with a lower boiling point than the boiling point of the first material.

Another aspect of the present invention is a system for manufacturing a capacitor. The capacitor includes a main body in which dielectric layers and electrode layers are alternatively laminated, and at least part of the main body is to be connected to an external electrode. The system includes: a chamber that provides a reduced pressure environment (condition); a transferring apparatus that transfers (conveys) a workpiece for the main body inside the chamber during manufacturing; and a dielectric layer forming apparatus that is configured to form the dielectric layer on the workpiece, a first metal layer forming apparatus that is configured to form a first metal layer including an internal electrode part and a connecting part that is to be connected to the external electrode, and a second metal layer forming apparatus that is configured to form a second metal layer on the connecting part, the dielectric layer forming apparatus, the first metal layer forming apparatus, and the second metal layer forming apparatus being disposed along the transferring apparatus inside the chamber. The system further includes: a first patterning apparatus that is disposed upstream of the first metal layer forming apparatus, and configured to perform patterning on the dielectric layer to form a first pattern for separating one end of the connecting part from the internal electrode part using a first material that evaporates when the first metal layer is formed; and a second patterning apparatus that is disposed between the first metal layer forming apparatus and the second metal layer forming apparatus and configured to perform patterning to form a second pattern using a second material that evaporates when the second metal layer is formed in a region including at least part of the first gap in the first metal layer formed by the first pattern.

The second patterning apparatus may include an apparatus that is configured to perform patterning to form a stopper, which sets a position at an opposite end of the second metal layer to an end formed by the second pattern, using the second material in parallel with the patterning to form the second pattern. The second patterning apparatus may include: a first aperture for vapor deposition of the second material that performs patterning to form the second pattern; and a second aperture, with a different-sized opening to the first aperture, for vapor deposition of the second material that performs patterning to form the stopper. The second patterning apparatus may include: a first sub-device (sub-unit) that includes a plurality of the first apertures and is capable of shifting the plurality of first apertures in a direction that is perpendicular to a transferring direction of the transferring apparatus; and a second sub-device (sub-unit) that includes a plurality of the second apertures and is capable of alternately shifting the plurality of second apertures in an opposite direction to the first sub-device (sub-unit).

The second patterning apparatus may include a wobbling apparatus that is configured to wobble a position of the second pattern in a range that does not exceed the first gap (within the range of the first gap). The dielectric layer forming apparatus may include an apparatus that performs vapor deposition of a resin material that forms (constructs) the dielectric layer in the reduced pressure environment (condition), the first metal layer forming apparatus may include an apparatus that performs vapor deposition of a first metal that forms (constructs) the first metal layer on the dielectric layer in the reduced pressure environment (condition), and the second metal layer forming apparatus may include an apparatus that performs vapor deposition of a second metal that forms (constructs) the second metal layer on the first metal layer in the reduced pressure environment (condition). This system may further include an apparatus that is disposed along the transferring apparatus inside the chamber and cures the resin material, which is thermosetting.

### BRIEF DESCRIPTION OF DRAWINGS

FIG. 1 schematically depicts a capacitor.

FIG. 2 is a cross-sectional view schematically depicting active layers (multilayer body).

FIG. 3 is a flowchart depicting an overview of a method of manufacturing a capacitor.

FIG. 4 depicts one example of a manufacturing process of active layers.

FIG. 5 depicts one example of a manufacturing process of active layers.

FIG. 6 depicts one example of a layer forming system.

FIG. 7 depicts one example of a plurality of sub-devices of a second patterning apparatus.

### DESCRIPTION OF EMBODIMENTS

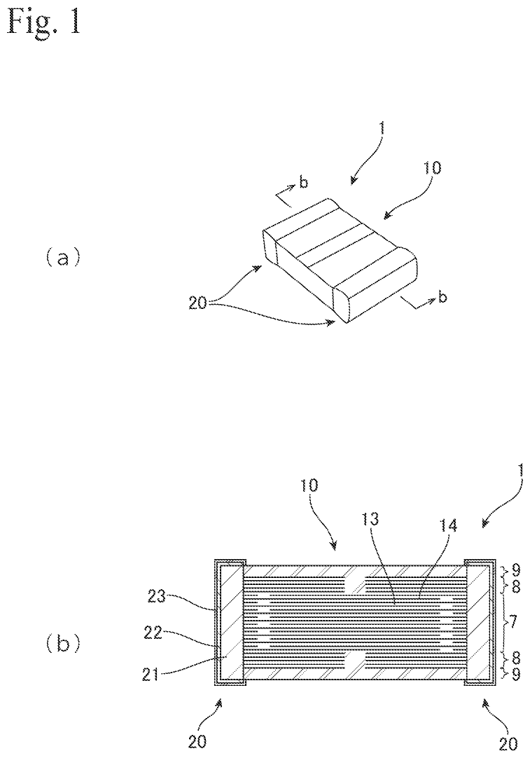

FIG. 1 depicts one example of a capacitor according to the present invention. A known example of a capacitor 1, which includes a main body (main body portion, capacitor core, core, laminated body, multilayer body, or multilayer product) 10 in which dielectric layers and electrode layers are alternatively laminated (stacked) and integrated, and external electrodes 20 each connected to the main body 10, is a polymer multi-thin-layer capacitor (Polymer Multi-Layer CAPacitor, thin-film polymer multilayer capacitor). The capacitor 1, whose external appearance is depicted in FIG. 1(a), is one example of a polymer multi-thin-layer capacitor. As depicted in the cross-sectional view in FIG. 1(b), the main body 10 includes active layers 7, which are provided at the center in the thickness direction and realize a capacitance, dummy layers 8 that are disposed above and below the active layers 7 and do not realize a capacitance, and protective layers 9 disposed of above and below the dummy layers 8. The active layers 7 and the dummy layers 8 are constructed by resin layers (or “dielectric layers”) 13 and electrode layers 14 stacked with each other, but the protective layers 9 are composed of only resin. The external electrodes 20 are formed so as to be joined or contacted to the electrode layers 14, and the resin layers 13 in the active layers 7 and the dummy layers 8, and each include an internal metallikon layer (metalized layer, as one example, brass metallikon) 21, a copper plating layer 22 for covering the periphery of the internal metallikon layer 21, and a tin plating layer 23 for further covering the outside.

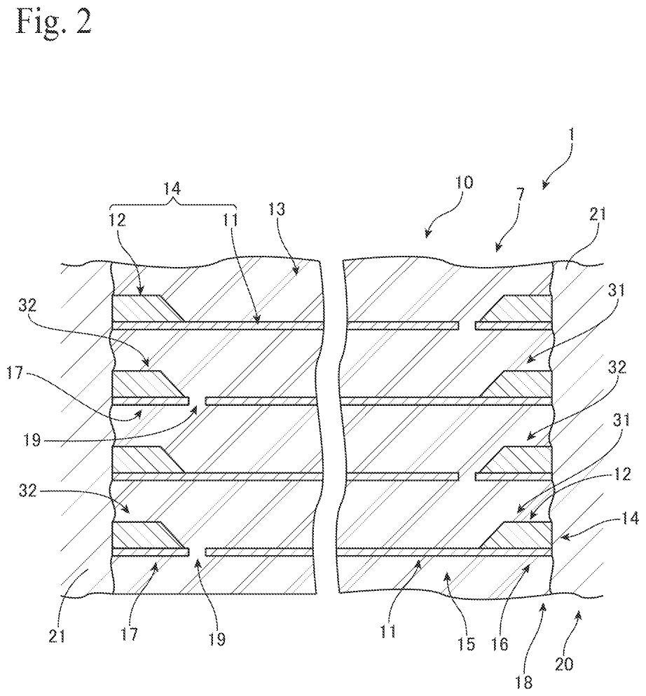

FIG. 2 depicts an enlarged cross-section of a part of the active layers 7 of the main body 10. The active layers 7 of the main 10 are a part where the dielectric layers 13 and the electrode layers 14 are stacked with each other. End portions (side surfaces, edge portions, connecting parts, connecting regions, or connection boundaries) 18 of the dielectric layers 13 and the electrode layers 14 are bonded to the metallikon layer 21 of each external electrode 20, with the electrode layers 14 also being electrically connected to the metallikon layer 21. The electrode layers 14 each have a two-layer structure, with a first metal layer 11 and a second metal layer 12. The first metal layer is formed on a dielectric layer 13 including an internal electrode part 15, in the form of a thin layer film which is in wide contact with the dielectric layer 13 inside the active layers 7 and forms a capacitance, and connecting parts 16 and 17 that are connected to the external electrodes 20 (the metallikon layers 21). The second metal layer 12 is deposited on the connecting parts 16 and 17 of the first metal layer 11 and, as the electrode layer 14, construct heavy edge portions 31 and 32 where the connecting boundaries 18 are thicker than the internal electrode part 15. That is, in the present embodiment, each heavy edge portion 31 and 32 that forms the electrode thickness at a connection boundary 18 of an electrode layer 14 is composed of the first electrode layer 11 and the second metal layer 12 that is laminated or stacked on the first electrode layer 11. To provide a capacitor 1 with a high withstand voltage, it is desirable to reduce the thickness of the internal electrode layer (internal electrode part) 15 and as examples, the thickness of the internal electrode layer 15 may be 0.01 μm, or may be even thinner at 0.005 μm (5 nm) or below. On the other hand, when considering the connections to the external electrodes 20, it is believed that a thickness of around 0.01 μm or greater is required. It is desirable to provide the heavy edge portions 31 and 32 in a capacitor 1 provided with thin film or layer-type internal electrode parts 15.

One example of the resin that constructs or forms the dielectric layer 13 is a thermosetting resin, and includes acrylic polymer. One example of a resin that can be used in the polymer multi-thin-layer capacitor 1 is a polymer in which one or more of tricyclodecane dimethanol dimethacrylate or tricyclodecane dimethanol diacrylate have been polymerized, but the resin that forms the dielectric layer 13 is not limited to these materials. To provide a small, thin, and high-capacity capacitor, the dielectric layers 13 may be made sufficiently thin and stacked in a sufficient number. As examples, the thickness of each of the dielectric layers 13 may be 0.1 to 1.5 μm, or 0.2 to 1.2 μm, and the number of layers may be 1,000 or higher. Dielectric layers 13 of a predetermined thickness can be obtained, as one of examples, by vapor deposition of a thermosetting resin as a monomer in a reduced pressure environment (that is, in a vacuum) and curing the resin through irradiation with an electron beam or the like. A capacitor 1 with dielectric layers 13 made of thermosetting resin has a higher withstand temperature than a capacitor made of a thermoplastic resin, is compatible or applicable with reflowing, and can, therefore, be provided as an element that is more suited to surface mounting.

The first metal layer 11 and the second metal layer 12 may be formed of a conductive metal, for example, at least one of aluminum, zinc, copper, gold, silver, and an alloy containing any of these metals, and may be deposited by vapor deposition, coating, sputtering, or printing using an inkjet or the like. As a capacitor 1 for high-voltage applications, the withstand voltage can be improved by reducing the thickness of the electrodes that function as a capacitor, that is, the internal electrode parts 15. As one example, the withstand voltage may be 400V or higher, and the thickness of the internal electrode parts 15 may be around 10 to 160 nm, or around 15 to 150 nm. Surface resistivity may be used to control the thickness of the thin layer film electrodes, and the surface resistivity of the internal electrode parts 15 may be 5 to 80 Ω/square (Ω/sq.), 15 to 80 Ω/sq., or 20 to 80 Ω/sq.

Each first metal layer 11 includes a connecting part 16 that is formed in a succession of (connected to) the internal electrode part 15 and a connecting part 17 that is separated (disconnected) by an inner margin (margin portion, or gap) 19. Each second metal layer 12 is deposited on each of the connecting parts 16 and 17, so that a heavy edge portion 31 that is connected to the internal electrode part 15 is constructed by the connecting part 16 of the first metal layer 11 and the second metal layer 12, and a dummy heavy edge portion 32 that is not connected to the internal electrode part 15 is constructed by the connecting part 17 of the first metal layer 11 and the second metal layer 12. Since the dummy edge portions 32 are separated (disconnected) from the internal electrode part 15, the dummy heavy edge portions 32 do not contribute to the capacitance of the capacitor 1. However, such dummy heavy edge portions 32 are useful in achieving mechanically strong connections with the metallikon parts 21 of the external electrodes 20, because the dummy heavy edge portions 32 help maintain or strengthen the connections between the metallikon layers 21 and the heavy edge portions 31, which are integrally connected with the internal electrode parts 15.

Although the withstand voltage can be increased when the internal electrode parts 15 are made thinner, the connection resistance between the internal electrode parts 15 and the external electrode 20 will increase. For this reason, the loss factor (tan δ) and the equivalent series resistance (ESR) both increase, so that the performance as a capacitor will tend to decrease. For this reason, the configuration of the connecting parts 18 of the electrode layers 14 and the external electrodes 20 is important. Even when the internal electrode parts 15 are thin, by constructing the heavy edge portions 31 that are thick at the connecting parts 18 that is a boundary for connecting with the external electrodes 20, in the present embodiment, to the metallikon layers 21, it is possible to reduce the tan δ and the ESR, to improve the frequency characteristics, and to provide a capacitor 1 that can handle large currents.

However, when attempts are made to form the heavy edge portions 31 and 32 with the required thickness and width using the second metal layer 12, there is the risk that an unneeded metal layer, that might be thin, will be formed in the periphery of the heavy edge portions 31 and 32. If a metal layer formed in the periphery of the heavy edge portions 31 and 32 were to touch (adhere to, or laminated on) the inner margin 19 and/or the internal electrode part 15 that constructs the active layer 7, this could have an adverse effect on reliability, such as a fall in the insulation resistance and/or the withstand voltage. On the other hand, if the position of the inner margin 19 were moved inward or the width of the margin were increased to avoid these problems, the area that does not function as a capacitor would increase, and the proportion of the internal electrode parts 15 would relatively decrease. This means that a problem could arise in that the capacitor would have to be made larger to obtain a predetermined performance.

It would be possible to increase the amount of liquid, as one example, margin oil for aluminum electrodes, applied to form the inner margin 19 when depositing the first metal layer 11 and then use or maintain this liquid when forming the second metal layer 12. When doing so, by the increased amount of margin oil, it is possible to remove the metal of the heavy edges that have adhered to the margins using the oil. However, since the amount of oil used to form the inner margin increases, it becomes difficult to form appropriate margins, due to reasons such as mixing of the semi-cured resin layer and the oil. In addition, in the case of an internal series type capacitor used in high voltage products, problems arise in which the states of the margins, such as the gap distance and the presence or absence of minute short circuits, vary greatly between margins positioned close to heavy edges and margins provided inside, which makes it difficult to stably manufacture highly reliable capacitors 1.

For this reason, according to the present invention, every time the plurality of metal layers 11 and 12 that construct the electrode layer 14 are formed, the pattern or patterns for making (keeping, securing, reserving) the areas (margins) where the metal layer forming is not performed are pre-formed with a low or moderate amount of oil or other margin material so that the material used will evaporate due to the heat of the metal layer forming. This means that the respective metal layers 11 and 12 are precisely formed (deposited), and it is possible to stably produce a capacitor 1 with the electrode layers 14 of a predetermined shape with high overall accuracy. That is, when forming the first metal layer 11, patterning is performed for a first pattern (margin) so that the pattern will evaporate due to the heat of the metal material which is supplied in a vaporized or fluidized state. Next, when forming the second metal layer 12, patterning is performed in the same way for a second pattern (margins) so that the material of the pattern evaporates due to the heat of the metal material supplied to form the second metal layer 12. In parallel with the patterning of the second pattern, patterning may be performed using the same material for a stopper that sets the position of an edge (second edge) of the second metal layer 12 on the opposite side to the edge (first edge) formed by the second pattern.

According to this manufacturing method, the material that is patterned to form the margin pattern and the stopper during forming, such as deposition, can evaporate and disappear or be placed in a state where the material has hardly any effect on downstream manufacturing processes. This improves precision, including the shape and thickness of the heavy edge portions 31 and 32, which are thick layer regions composed of the plurality of the metal layers 11 and 12. It is also possible to prevent a drop in the performance of capacitor 1 due to the mixing of the material forming the patterns with the material forming the dielectric layers 13.

In addition, by performing patterning again for a second pattern (second margins) that forms margins during the forming of the next layer (deposition) in areas that include at least part of the gaps (first gaps) formed by the first pattern, an inner margin 19 can be reliably formed and kept between the heavy edge portion 32 and the internal electrode part 15. That is, although the first pattern is vaporized and disappears due to the deposition of the internal electrode part 15, by providing the second pattern so that it overlaps the inner margin 19 at least partially, the second pattern can cover the part that will become the inner margin 19 and thereby prevent the inner margin 19 from being lost. This makes it possible to prevent the problem of the heavy edge portion 32, which is provided as a thick layer region and is supposed to be separated (disconnected), and the internal electrode part 15, which is provided in a thin layer region, being connected by a thin metal layer, which would cause short circuits and interference.

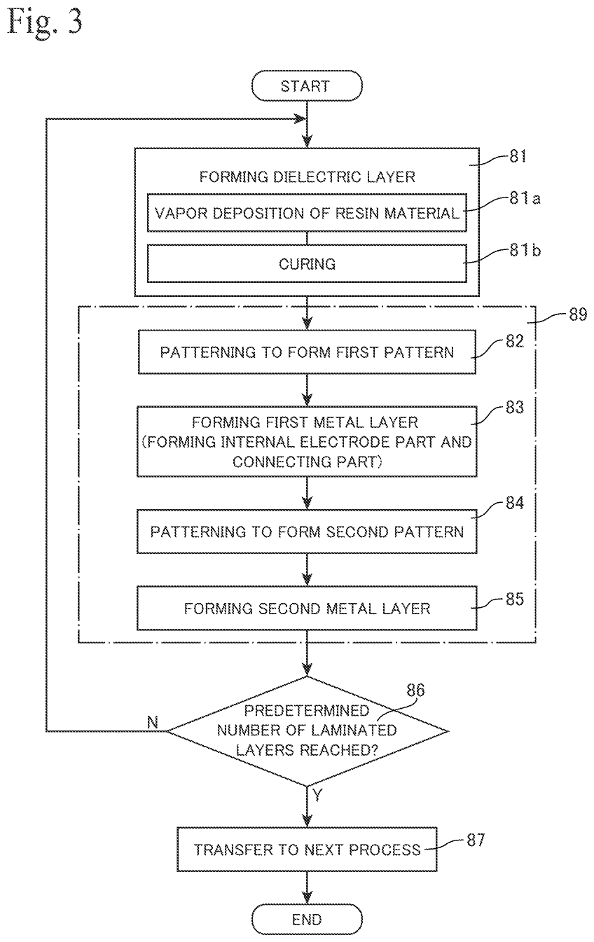

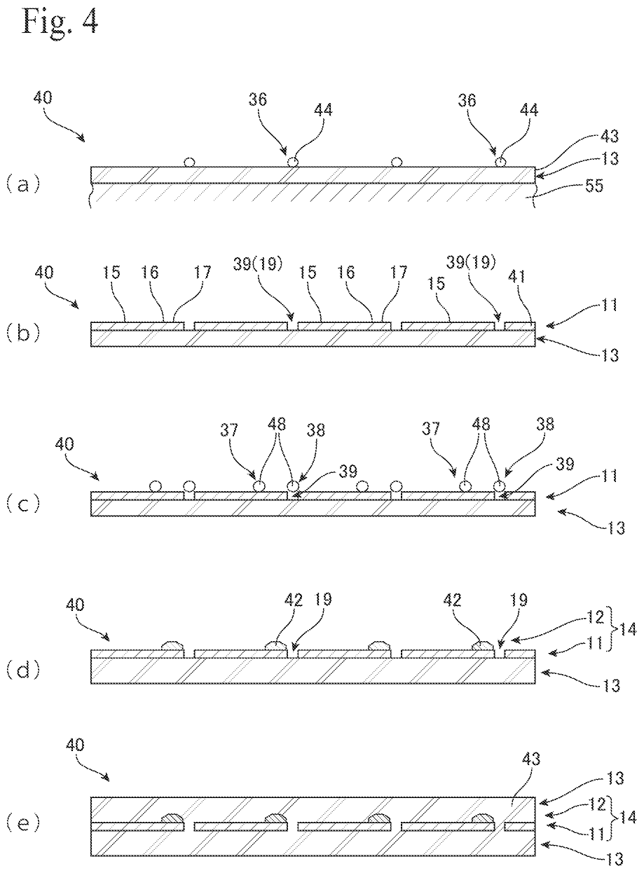

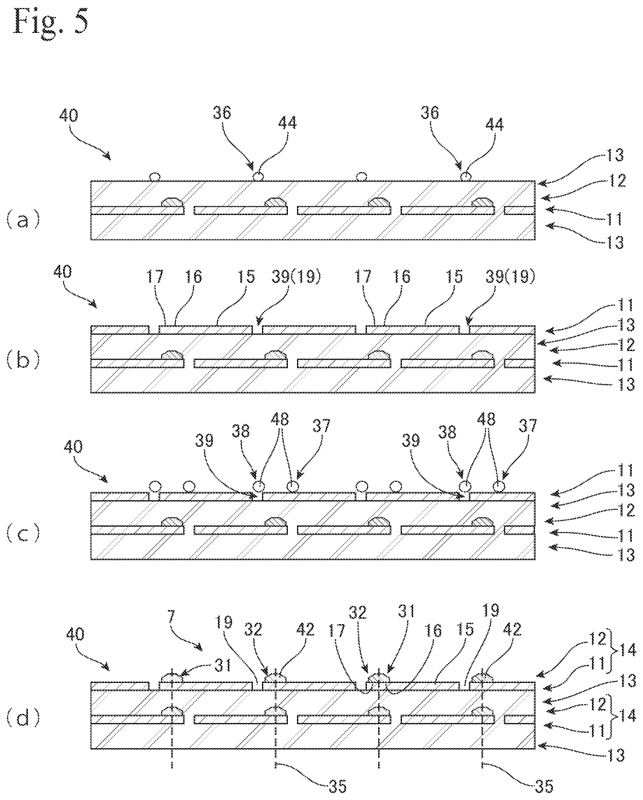

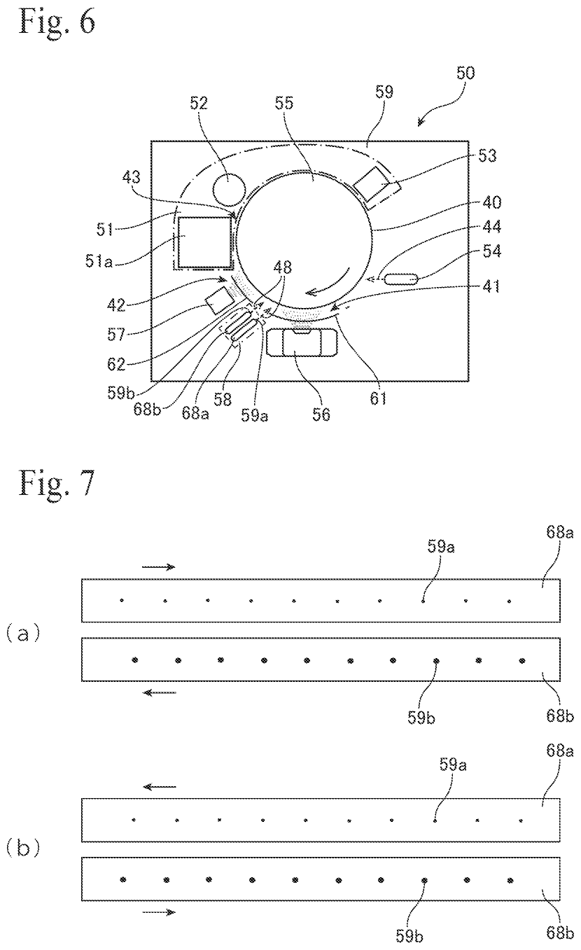

FIG. 3 is a flowchart depicting one example of a process for manufacturing the active layers 7, which is the multilayer part of the main body 10 of the capacitor 1 according to the present embodiment, using a layer forming system (deposition system, film-layer forming apparatus or film forming system) and FIGS. 4 and 5 schematically depict how the respective layers are stacked. FIG. 6 is an overview of the layer forming system (deposition system, film-layer forming apparatus) 50 used as a system for manufacturing the capacitor 1. The layer forming system 50 includes a vacuum chamber 59 and a drum 55 that rotates in a reduced pressure environment (vacuum environment, reduced pressure condition) inside the vacuum chamber 59 and conveys or transfers a workpiece 40 for manufacturing the main body or the main bodies 10. Note that although an example where the drum 55 is used as a transferring apparatus (conveying apparatus, conveyer) and the continuously formed workpiece or workpieces 40 are formed on the drum 55 and conveyed is described in the present embodiment, it is also possible to convey a plurality of workpieces 40 intermittently using the drum 55. The layer forming system 50 is a manufacturing apparatus (manufacturing system) that uses vapor deposition and further includes a dielectric layer forming unit (dielectric layer forming apparatus) 51 that is configured to form the dielectric layer 13 on the workpiece 40, a first metal layer forming unit (first metal layer forming apparatus) 56 that is configured to form the first metal layer 11 including the internal electrode part 15 and a connecting part, which is to be divided to the connecting parts 16 and 17, on the dielectric layer 13, and a second metal layer forming unit (second metal layer forming apparatus) 57 that is configured to form the second metal layer 12 on the connecting parts 16 and 17.

The layer forming system 50 further includes a first patterning unit (first patterning apparatus) 54 disposed upstream of the first metal layer forming unit 56, that is, between the dielectric layer forming unit 51 and the first metal layer forming unit 56, and a second patterning unit (second patterning apparatus) 58 disposed between the first metal layer forming unit 56 and the second metal layer forming unit 57. The first patterning unit 54 is configured to perform patterning for first patterns (first margins) 36 for separating one end of the connecting part 17 from the internal electrode part 15 using a first material 44 that evaporates when the first metal layer 11 is formed. The second patterning unit 58 is configured to perform patterning for forming second patterns (second margins) 38 using a second material 48 that evaporates when the second metal layer 12 is formed in a region including at least a part of the gap (first gap) 39 formed by the first patterns 36. The second patterning unit 58 may further include a function as an apparatus that is configured to perform patterning, using the second material 48 and in parallel with the patterning of the second patterns 38, for stoppers 37 that set the position of end (edge) on the opposite side of the second metal layer 12 to the end (edge) formed by the second patterns 38. The second patterning apparatus 58 may also include a function as a wobbling apparatus that is configured to vary or wobble the positions of the second patterns 38.

One example of the first material (patterning material) 44 and the second material 48 used for patterning (printing, coating) the patterns that become the margins is material in liquid form (liquid material), and may be at least one type of oil selected from a group composed of ester oils, glycol oils, fluorine oils, and hydrocarbon oils. The first material 44 and the second material 48 may be ester-based oils, glycol-based oils, or fluorine-based oils, with fluorine-based oils being especially preferable. These materials 44 and 48 may be oils with an evaporation temperature (boiling point) of around 100 to 200° C. in a reduced pressure environment of around 0.1 Pa. These materials 44 and 48 may be fluorine-based oils with an average molecular weight of around 1,500 to 3,000.

The dielectric layer forming apparatus 51, the first patterning apparatus 54, the first metal layer forming apparatus 56, the second patterning apparatus 58, and the second metal layer forming apparatus 57 are disposed around a drum 55, which is the transferring apparatus for transferring or conveying the workpiece 40 for the main body 10 that are being manufactured inside the chamber 59 that provides a reduced pressure environment. Accordingly, in the layer forming system 50, the dielectric layer 13 and the electrode layer 14 composed of the metal layers 11 and 12, are continuously laminated (stacked) in a reduced pressure environment. The layer forming system 50 may include a third and/or fourth metal layer forming apparatus, may include a third and/or fourth patterning apparatus, and may manufacture a capacitor including an electrode layer 14 with a multilayer structure of three or more layers (sub-layers).

The dielectric layer forming apparatus 51 may also include, in order along the rotating drum 55, a monomer vapor deposition unit (monomer vapor deposition apparatus) 51 for vapor deposition of resin material 43, an electron beam irradiation apparatus 52 for curing the thermosetting resin material 43, and a plasma processing apparatus 53 that performs a surface treatment. The first metal layer forming apparatus 56 may have a function as a first vapor deposition unit (first vapor deposition apparatus) that is configured to vapor deposit (vapor deposition of) the first metal 41 via a metal mask 61 with a first deposition pattern (first layer forming pattern), and the second metal layer forming apparatus 57 may have a function as a second vapor deposition unit (second vapor deposition apparatus) that is configured to vapor deposit (vapor deposition of) the second metal 42 via a metal mask 62 with a second deposition pattern (second layer forming pattern).

Although the present invention will be described below using an example in which the active layers 7, which is a multilayer body (laminated part), are manufactured by vapor deposition, each layer may be formed by another method such as coating, sputtering or printing, and when using a component or components that have already been manufactured, such as a film or films as the dielectric layer film like in a film capacitor, a step of forming the dielectric layer may not be necessary, and may be performed separately from the step of forming the electrode layer.

First, as depicted in FIG. 3, the manufacturing method according to the present invention includes a step 81 of forming the dielectric layer 13 and a step 89 of forming the electrode layer 14 on the dielectric layer 13, and manufactures a multilayer active layer 7 by repeating these steps. In step 81, the thermosetting resin 43 for forming the dielectric layer 13 is applied by vapor deposition using a monomer vapor deposition apparatus 51a onto a lower layer that has been laminated on the drum 55. The applied thermosetting resin 43 is cured by the electron beam irradiation apparatus 52 to form the dielectric layer 13, and then the surface of the dielectric layer 13 is subjected to plasma treatment by the plasma treatment apparatus 53 in preparation for the next step. Accordingly, the step 81 of forming the dielectric layer 13 includes, in a reduced pressure environment, a step 81a of vapor depositing (vapor deposition of) the resin material (thermosetting resin) 43 that constructs the dielectric layer 13 and a step 81b of curing the thermosetting resin 43.

Next, as depicted in FIG. 4(a), in step 82, before forming the first metal layer 11, the first patterning apparatus 54 performs patterning on the dielectric layer 13 using the first material 44 to form a first pattern (first margin or oil margin) 36 for separating one connecting part 17, that is one end of the connecting part, from the internal electrode part 15.

Next, in step 83, as depicted in FIG. 4(b), the first metal layer deposition apparatus 56 performs vapor deposition of the first metal layer 41 via the metal mask 61 with the first layer forming a pattern on the dielectric layer 13 to form the first metal layer 11. The first metal layer 11 forms the internal electrode part 15 and the connecting parts 16 and 17. The first metal 41 may include either aluminum or an alloy of aluminum. Aluminum and aluminum alloys have a slightly higher resistivity (that is, lower electrical conductivity) than gold or copper, but are low cost, have a relatively low boiling point, and are easy to deposit by vapor deposition, which makes aluminum and aluminum alloys favorable materials for forming the internal electrode part 15. In this step, the internal electrode part 15 and one of the connecting parts 17 are separated from each other by the first pattern 36 produced by patterning using the first material 44. Since the first metal 41 that forms the first metal layer 11 is deposited in a vaporized state, the first material 44 that forms the first pattern 36 is vaporized by the heat during this deposition and disappears (becomes non-existent). Accordingly, the locations where the first patterns 36 were formed by patterning become locations (margins) where the first metal 41 is not attached or laminated (stacked), and after the first patterns 36 have disappeared, such locations become gaps (the first gaps) 39 that each separate the internal electrode part 15 and one connecting part 17.

Next, in step 84, as depicted in FIG. 4(c), before forming the second metal layer 12, the second patterning apparatus 58 performs patterning in regions including at least parts of the gaps 39 formed by the first patterns 36 to form the second patterns (second margins) 38 that form margins where the second metal 42 is not attached or laminated (stacked) using the second material 48, which evaporates when the second metal layer 12 is formed (deposited). Note that in the drawings, including FIGS. 4 and 5, the respective structures have been schematically depicted for ease of explanation. The thickness of each metal layer is 10 to 160 nm, clear vertical edges will not be formed, and the gaps 39 will not remain as hollows.

In step 84, in parallel with the above process, the second patterning apparatus 58 may use the second material 48 to perform patterning for the stoppers 37 that set or define the positions of the opposite ends of the second metal layer 12 to the ends formed by the second patterns 38. In addition, in step 84, the wobbling function (wobbling apparatus) of the second patterning apparatus 58 is used to wobble (that is, cause variation, varying the position) and form the second pattern 38 by moving the position minute distances, that is, within a range that does not completely deviate from the first gap 39. In the multilayer capacitor 1, by slightly varying the positions and shapes of the recesses (concave structures or stepped structures) in the inner margins 19 formed by the first patterns 36 and the second patterns 38, edges and slopes in concave structures or stepped structures can be softened or moderated. This means that the influence of the concave structures when forming the inner margins 19 on the overall shape and the performance of capacitor 1 can be mitigated.

As depicted in FIG. 6, the second patterning apparatus 58 may include a first sub-device (sub-unit) 68a for patterning to form the second patterns 38 and a second sub-device (sub-unit) 68b for patterning to form the stoppers 37. When performing patterning to form the stoppers 37 in parallel with the second patterns 38 in step 84, the stoppers 37 may be produced using a different amount of the second material 48 from the amount used to produce the second patterns 38.

FIG. 7(a) depicts an example of the first sub-unit 68a, and FIG. 7(b) depicts an example of the second sub-unit 68b. The first sub-unit 68a may include a plurality of first apertures (openings) 59a that are openings for applying the second material 48, and the second sub-unit 68b may include a plurality of second apertures (openings) 59b that are openings for applying the second material 48 for forming the stoppers 37 and have different sized openings to the first apertures 59a, as one example, larger apertures (openings). The positions of the second patterns 38 and the stoppers 37 are reversed between the n^{th} layer and the (n+1)^{th} layer. Accordingly, the first sub-unit 68a shifts the plurality of first apertures 59a in a direction (width direction) perpendicular to the moving direction of the drum 55, which is the transferring apparatus, and the second sub-unit 68b alternately shifts the plurality of second apertures 59b in the opposite direction to the first sub-unit 68a. FIG. 7(a) depicts an arrangement of the first apertures 59a and the second apertures 59b for the n^{th} layer, and FIG. 7(b) depicts the arrangement of the first apertures 59a and the second apertures 59b for the (n+1)^{th} layer.

When the second material 48 is applied by vapor deposition, the conditions of the material underneath differ between the second patterns 38 and the stoppers 37. For this reason, the amount of the applied second material 48 may be changed or differ between the second patterns 38 and the stoppers 37 depending on the condition of their material underneath, which can contribute to an improvement in the quality of the manufactured capacitors. In this case, as one example, the second patterning apparatus 58 may include the first sub-unit 68a including the first apertures 59a for controlling application amounts of the second patterns 38 and a second sub-unit 68b with the second apertures 59b for controlling application amounts of the stoppers 37, which may be realized by adjusting the sizes (areas) of the respective apertures (openings). In more detail, the two subunits 68a and 68b are provided with the openings 59a for patterning to form the second patterns 38 and the openings 59b for patterning to form the stoppers 37 that have different-sized openings, with these being moved (shifted) in the width direction of the drum one layer at a time (layer-by-layer).

After this, in step 85, the second metal layer 12 is formed on the connecting parts 16 and 17. In more detail, as depicted in FIG. 4(d), the second metal layer 42 is formed by vapor deposition on limited regions, which are demarcated by the second patterns 38 and the stoppers 37, via the metal mask 62 with the second deposition pattern using the second metal layer forming apparatus 57 to form the second metal layer 12 on the connecting parts 16 and 17 of the first metal layer 11. The second metal 42 may include either zinc or an alloy of zinc. The boiling point of zinc is 907° C., which is lower than 2520° C., the boiling point of aluminum. Accordingly, the vapor deposition apparatus for the second metal, such as zinc, can be provided at a lower cost than a vapor deposition apparatus for aluminum, and the running cost can also be reduced. Also, although slightly higher than aluminum, the resistivity of zinc is also sufficiently low, so zinc can be used as electrodes to construct the connecting areas (edge parts) 18 that connect to the external electrodes 20.

In this step, the second material 48 that formed the second patterns 38 and the stoppers 37 defining both ends of the second metal layer 12 evaporates and disappears due to the heat during vapor deposition of the second metal 42 forming the second metal layer 12. The second metal 42 may include either zinc or zinc alloy, and since the boiling point of zinc is lower than that of aluminum, a material (liquid material) 48 with a lower boiling point than the first material 44 may be used to form the second patterns 38 and the stoppers 37. The second patterns 38 are formed on or in the gaps 39 formed by the first patterns 36, and the second material 48 that forms the second patterns 38 evaporates, thereby forming structures that become the inner margins 19 that separate the inner electrode part from the heavy edge portions. That is, the step 85 of patterning to form the second patterns may include patterning to form the second patterns 38 and the stoppers 37 using the second material 48 that has a different boiling point from the boiling point of the first material 44 according to the metal materials of the first metal layer 11 and the second metal layer 12, the vapor deposition conditions, and the like. In more detail, step 85 may include patterning to form the second patterns 38 and the stoppers 37 using the second material 48 that has a lower boiling point than the boiling point of the first material 44.

In step 86, the steps described above are repeated until the number of stacked layers reaches a predetermined value. That is, as depicted in FIG. 4(e), in step 81, the dielectric layer forming apparatus 51 laminates (stacks, deposits) the thermosetting resin 43 on the electrode layer 14 composed of the first metal layer 11 and the second metal layer 12 to form the dielectric layer 13. In step 82, as depicted in FIG. 5(a), the first patterns 36 are formed by patterning by the first patterning apparatus 54 using the first material 44 on the dielectric layer 13. Then, in step 83, as depicted in FIG. 5(b), the first metal 41 is deposited on the dielectric layer 13 by the first metal layer forming apparatus 56 to form the first metal layer 11 including the internal electrode part 15 and the connecting parts 16 and 17.

In step 84, as depicted in FIG. 5(c), the second patterning apparatus 58 performs patterning to form the second patterns 38 in regions including at least part of the gaps 39 formed by the first patterns and the stoppers 37 using the second material 48. After this, in step 85, as depicted in FIG. 5(d), the second metal layer 12 is formed on the connecting parts 16 and 17 by the second metal layer forming apparatus 57 using the second metal 42.

When a multilayer body (laminated structure) in which the dielectric layers 13 and the electrode layers 14 are alternatively laminated (stacked) has been manufactured by repeating the above steps, by cutting at the thick connecting parts that have been made thicker by the laminated second metal layer 12 as depicted by the broken lines 35 in FIG. 5(d), it is possible to manufacture parts that function as the active layers 7 including the heavy edge portions 31 and 32. After this, in step 87, the cut workpieces are transferred to the next process for manufacturing capacitor 1.

As described earlier, in the present invention, the second patterning apparatus 58 is disposed in the layer forming system 50 and forms the second patterns 38 using the second material 48, such as oil, before the second metal layer 12 for forming the heavy edge portions 31 and 32 is laminated (made, stacked) by vapor deposition. Together with the second patterns 38, the stoppers 37 may be provided so that the same material, for example, oil, is applied by vapor deposition at positions on both sides of the second metal layer 12, and the material 48 for forming margins, such as oil, may be applied at locations that differ from the first patterns 36 used for the metal layer 11 that forms the main component of the electrode layer 14. The positions of the first patterns 36, the second patterns 38, and the stoppers 37 may be wobbled (that is, finely shifted repeatedly) to soften or moderate the shapes of the recesses formed by these patterns as margins.

In one of the embodiments, the first metal 41 that constructs the electrode layer 14 is assumed to be aluminum, and the second metal 42 that constructs the heavy edge portions 31 and 32 is assumed to be zinc, in this case, the evaporation temperatures of the deposited metals will differ. Accordingly, the materials 44 and 48, as one example, the types of oil, forming the patterns that serve as the margins may be changed in keeping with the types of metal that form the first metal layer 11 and the second metal layer 12, respectively. In more detail, when the second metal layer 12 is formed of zinc, which has a lower boiling point, an oil with a lower boiling point may be used as the second material 48 that forms the second pattern 38 and the stopper 37. When the patterning materials 44 and 48 are oils, both materials may be fluorine-based oils.

With the manufacturing method and manufacturing system according to the present invention, when the electrode layer 14 is made thicker to produce a multilayer structure that constructs the heavy edge portions 31 and 32, excessive parts of the metal layer 12 that is applied can be removed by the margins (that is, the second patterns 38 and the stoppers 37) made each time by the patterning process. This means that the effective area as the capacitor 1 can be maximized while providing the electrode layer 14 that has the heavy edge portions 31 and 32, that is, parts where the thickness of the electrode layer 14 differs. This means that the capacitor 1 can be miniaturized. In this invention, gaps (inner margin) 19 for separating one side of heavy edge portions 32 of both sides from the internal electrode part 15 can be provided in an appropriate state, which can improve the reliability and yield of the capacitor 1. Even when an internal series structure is used, the margins can be formed appropriately and uniformly, which can improve the reliability and yield of capacitors.

Note that although specific embodiments of the present invention have been described above, various other embodiments and modifications will be conceivable to those of skill in the art without departing from the scope and spirit of the invention. Such other embodiments and modifications are addressed by the scope of the patent claims given below, and the present invention is defined by the scope of these patent claims.

1. A method of manufacturing a capacitor, the capacitor including a main body in which dielectric layers and electrode layers are alternatively laminated, with at least part of the main body being to be connected to external electrodes,
the method comprising forming an electrode layer on a dielectric layer,
wherein the forming of the electrode layer includes:
forming a first metal layer including a connecting part, which is to be connected to the external electrode, and an internal electrode part; and
forming a second metal layer on the connecting part, and
the method further comprises:
patterning, before the forming of the first metal layer, on the dielectric layer to form a first pattern for separating one end of the connecting part from the internal electrode part using a first material that evaporates when the first metal layer is formed; and
patterning, between the forming of the first metal layer and the forming of the second metal layer, to form a second pattern using a second material that evaporates when the second metal layer is formed on a region including at least part of a first gap in the first metal layer formed by the first pattern.

2. The method of manufacturing according to claim 1,
further comprising patterning to form a stopper, which sets a position at an opposite end of the second metal layer to an end formed by the second pattern, using the second material in parallel with the patterning to form the second pattern.

3. The method of manufacturing according to claim 2,
wherein the patterning to form the stopper includes patterning to form the stopper using a different amount of the second material than an amount of the second material used in the patterning to form the second pattern.

4. The method of manufacturing according to claim 1,
wherein the patterning to form the second pattern includes wobbling a position of the second pattern in a range where the position of the second pattern does not exceed the first gap.

5. The method of manufacturing according to claim 1,
further comprising forming the dielectric layer, wherein the forming of the dielectric layer includes vapor deposition of a resin material that forms the dielectric layer in a reduced pressure environment,
the forming of the first metal layer includes vapor deposition of a first metal that forms the first metal layer on the dielectric layer, and
the forming of the second metal layer includes vapor deposition of a second metal that forms the second metal layer on the first metal layer.

6. The method of manufacturing according to claim 5,
further comprising curing the resin, which is thermosetting, following the vapor deposition of the resin material.

7. The method of manufacturing according to claim 1,
wherein the first metal layer includes one of aluminum and aluminum alloy, and
the second metal layer includes one of zinc and zinc alloy.

8. The method of manufacturing according to claim 1,
wherein the patterning to form the second pattern includes patterning to form the second pattern using the second material with a different boiling point to a boiling point of the first material.

9. The method of manufacturing according to claim 1,
wherein the patterning to form the second pattern includes patterning to form the second pattern using the second material with a lower boiling point than a boiling point of the first material.

10. A system for manufacturing a capacitor, the capacitor including a main body in which dielectric layers and electrode layers are alternatively laminated, with at least part of the main body portion being to be connected to an external electrode,
the system comprising:
a chamber that provides a reduced pressure environment;
a transferring apparatus that transfers a workpiece for the main body inside the chamber during manufacturing; and
a dielectric layer forming apparatus that is configured to form a dielectric layer on the workpiece, a first metal layer forming apparatus that is configured to form a first metal layer including an internal electrode part and a connecting part that is to be connected to the external electrode, and a second metal layer forming apparatus that is configured to form a second metal layer on the connecting part, the dielectric layer forming apparatus, the first metal layer forming apparatus, and the second metal layer forming apparatus being disposed along the transferring apparatus inside the chamber,
wherein the system further comprises:
a first patterning apparatus that is disposed upstream of the first metal layer forming apparatus, and configured to perform patterning on the dielectric layer to form a first pattern for separating one end of the connecting part from the internal electrode part using a first material that evaporates when the first metal layer is formed; and
a second patterning apparatus that is disposed between the first metal layer forming apparatus and the second metal layer forming apparatus and configured to perform patterning to form a second pattern using a second material that evaporates when the second metal layer is formed in a region including at least part of the first gap in the first metal layer formed by the first pattern.

11. The system according to claim 10,
wherein the second patterning apparatus includes an apparatus that is configured to perform patterning to form a stopper, which sets a position at an opposite end of the second metal layer to an end formed by the second pattern, using the second material in parallel with the patterning to form the second pattern.

12. The system according to claim 11,
wherein the second patterning apparatus includes:
a first aperture for vapor deposition of the second material that performs patterning to form the second pattern; and
a second aperture, with a different-sized opening to the first aperture, for vapor deposition of the second material that performs patterning to form the stopper.

13. The system according to claim 12,
wherein the second patterning apparatus includes:
a first sub-device that includes a plurality of first apertures and is capable of shifting the plurality of first apertures in a direction that is perpendicular to a transferring direction of the transferring apparatus; and
a second sub-device that includes a plurality of second apertures and is capable of alternately shifting the plurality of second apertures in an opposite direction to the first sub-device.

14. The system according to claim 10,
wherein the second patterning apparatus includes a wobbling apparatus that is configured to wobble a position of the second pattern in a range that does not exceed the first gap.

15. The system according to claim 10,
wherein the dielectric layer forming apparatus includes an apparatus that performs vapor deposition of a resin material that forms the dielectric layer in the reduced pressure environment,
the first metal layer forming apparatus includes an apparatus that performs vapor deposition of a first metal that forms the first metal layer on the dielectric layer in the reduced pressure environment, and
the second metal layer forming apparatus includes an apparatus that performs vapor deposition of a second metal that forms the second metal layer on the first metal layer in the reduced pressure environment.

16. The system according to claim 15,
further comprising an apparatus that is disposed along the transferring apparatus inside the chamber and cures the resin material, which is thermosetting.
